(19) United States
(12) Patent Application Publication
(10) Pub. No.: US 2014/0301429 A1
(43) Pub. Date: Oct. 9, 2014

(54) DATA PROCESSING METHODS PERFORMED BY UMTS-FDD DEVICE

(71) Applicant: MEDIATEK INC., Hsin-Chu (TW)

(72) Inventor: Jeng-Yi Tsai, Hsinchu City (TW)

(73) Assignee: MEDIATEK INC., Hsin-Chu (TW)

(21) Appl. No.: 14/109,921

(22) Filed: Dec. 17, 2013

Related U.S. Application Data
(60) Provisional application No. 61/807,872, filed on Apr. 3, 2013.

(51) Int. Cl. H04B 1/707; H04B 7/26

(52) U.S. Cl. CPC H04B 1/707; H04B 7/26
USPC 375/140

(57) ABSTRACT

A data processing method performed by a Universal Mobile Telecommunications System Frequency Division Duplexing (UMTS-FDD) device includes at least the following steps: generating a control frame and a data frame, wherein the data frame is spread according to a fixed spreading factor which is not greater than a minimum spreading factor prescribed in a UMTS-FDD Release 99 specification, and the control frame includes a transport format combination indicator (TFCI) data; and transmitting the control frames through an uplink dedicated physical control channel (UL DPCCH) and transmitting the data frames through an uplink dedicated physical data channel (UP DPDCH).

### CROSS REFERENCE TO RELATED APPLICATIONS

This application claims priority of U.S. Provisional Application No. 61/807,872, filed on Apr. 3, 2013, the entirety of which is incorporated herein by reference.

### BACKGROUND

The present disclosure relates generally to a Universal Mobile Telecommunications System Frequency-Division Duplexing (UMTS FDD) communications system, and in particular, to an uplink (UL) spreading and de-spreading method of a UMTS FDD communications system.

In a Universal Mobile Telecommunications System Frequency Division Duplexing (UMTS-FDD) environment, Orthogonal Variable Spreading Factor (OVSF) is an implementation of Code Division Multiple Access (CDMA) wherein, before each signal is transmitted, the signal is spread over a wide spectrum range through the use of an OVSF code. OVSF codes are mutually orthogonal to each other. Then the signal is scrambled with some scrambling codes to identify different Node Bs in downlink (DL) or to identify different User Equipments (UEs) in uplink (UL).

The flexible spreading factor scheme employed by UMTS-FDD Release 99 allows an uplink (UL) dedicated physical data channel (DPDCH) to dynamically switch its spreading factor between a set of spreading factors, specified by minimum spreading factor SFmin. The spreading factor set is a subset of 4, 8, 16, 32, 64, 128, and 256 that started from SFmin. For instance, a Node B performs pre-de-spreading over all possible spreading factors upon DPDCH. After Transport Format Combination Indicator (TFCI) content is derived from a dedicated physical control channel (DPCCH), the Node B will perform de-rate matching and decoding process upon the pre-de-spread result which correlates to the spreading factor indicated by the TFCI content.

In summary, the flexible spreading factor scheme leads to a complex de-spreading process for UL receivers.

### SUMMARY

In accordance with exemplary embodiments of the present invention, a UL spreading and de-spreading method of a UMTS FDD communications system is proposed to solve the above-mentioned problems.

According to a first aspect of the present invention, a data processing method performed by a Universal Mobile Telecommunications System Frequency Division Duplexing (UMTS-FDD) device is disclosed. The method comprises: generating a control frame and a data frame, wherein the data frame is spread according to a fixed spreading factor which is not greater than a minimum spreading factor prescribed in UMTS-FDD Release 99; and transmitting the control frame through an uplink dedicated physical control channel (UL DPCCH) and transmitting the data frame through an uplink dedicated physical data channel (UP DPDCH).

According to a second aspect of the present invention, a data processing method performed by a Universal Mobile Telecommunications System Frequency Division Duplexing (UMTS-FDD) device is disclosed. The method comprises: receiving a control frame through an uplink dedicated physical control channel (UL DPCCH) and a data frame through an uplink dedicated physical data channel (UP DPDCH); and processing the control frame and the data frame, wherein the data frame is spread according to a fixed spreading factor which is not greater than a minimum spreading factor prescribed in UMTS-FDD Release 99.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a system diagram of a UTRAN in a UMTS according to an embodiment of the invention.

FIG. 2 illustrates the slot configurations of a radio frame for the UMTS-FDD Release 99 UL DPCH.

FIG. 3 illustrates a slot format of a UL DPCCH slot according to an embodiment of the invention.

FIG. 4 depicts a rate matching method according to an embodiment of the invention.

FIG. 5 is a flowchart of a data processing method performed by a UMTS-FDD device according to an embodiment of the invention.

FIG. 6 is a flowchart of a data processing method performed by a UMTS-FDD device according to another embodiment of the invention.

FIG. 7 is a flowchart of a data processing method performed by a UMTS-FDD device according to yet another embodiment of the invention.

FIG. 8 is a flowchart of a data processing method performed by a UMTS-FDD device according to still yet another embodiment of the invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

Since 1999, the 3^{rd} Generation Partnership Project (3GPP) has released several versions of spread-spectrum-based mobile communications system, including Universal Mobile Telecommunications Systems (UMTS), High-Speed Packet Access (HSPA), and High-Speed Packet Access+ (HSPA+). The following discussions are based on UMTS Frequency-Division Duplexing (FDD) communications system, which is also called UMTS-FDD Release 99 to discriminate from later releases which include new features.

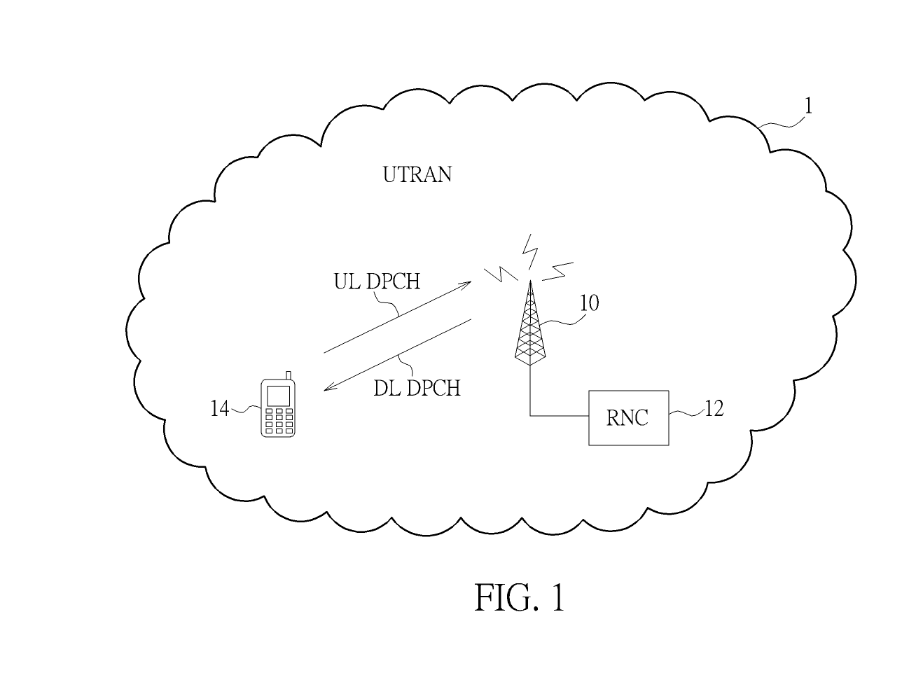

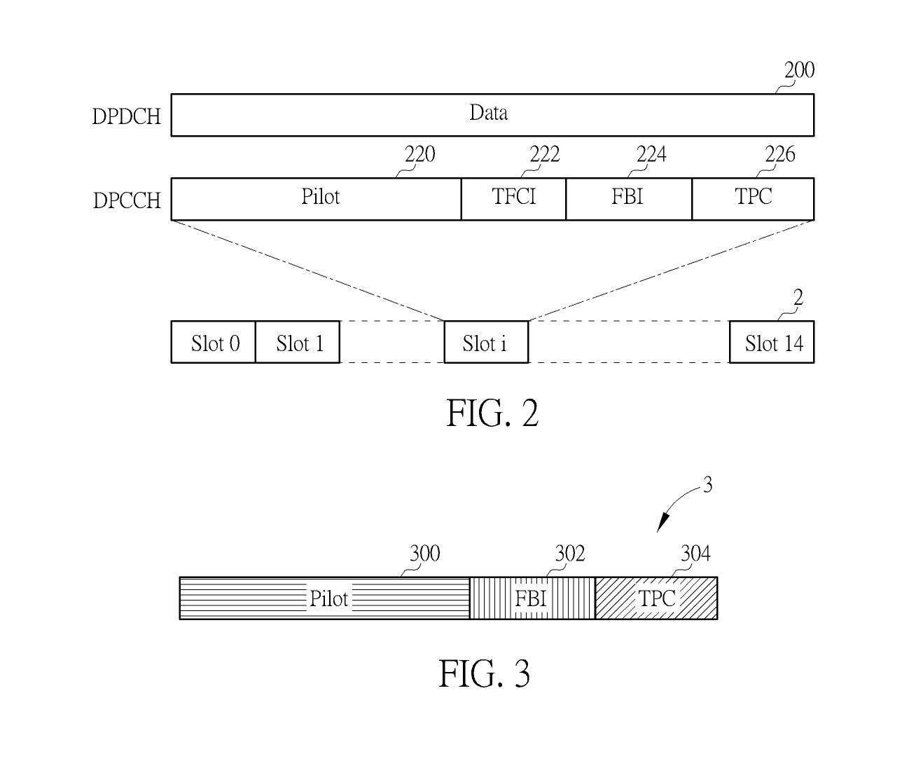

FIG. 1 is a system diagram of a UMTS Terrestrial Radio Access Network (UTRAN) 1 in a UMTS according to an embodiment of the invention. The UTRAN 1 has a Node B 10 and a radio network controller (RNC) 12. For a circuit-switched (CS) service such as a voice or speech service, a user equipment (UE) 14 can communicate with the node B 10 by communications channels including an uplink dedicated physical channel (UL DPCH) and a downlink dedicated physical channel (DLDPCH). The UE 14 may be a notebook computer with a dongle device, a mobile phone, or other mobile communications device capable of performing wireless communications with the Node B 10. The RNC 12 is connected to and controls a plurality of Node Bs. The Node B 10 includes a transmitter (not shown), a receiver (not shown) and a control circuit (not shown). The UTRAN 1 implements a blind transport format detection (BTFD)/TFCI scheme for the circuit switched service on the Node B 10 according to various embodiments of the invention characterized by a fixed spreading factor of the UL DPCH, as detailed by FIGS. 2-8. The BTFD scheme is operational without the use of TFCI data, while the TFCI scheme is operational with the use of TFCI data.

The BTFD/TFCI scheme implemented in the Node B 10 is briefly explained as follows. The Node B 10 is configured to determine a transport format combination as well as a slot format of a circuit-switched data by pre-de-spreading the received data with a fixed spreading factor and then applying de-rate matching to the de-spread data with a plurality of de-rate matching schemes. The Node B 10 can determine a correct transport format combination as well as a correct slot format for the circuit-switched data based on de-rate matched data. When the TFCI scheme is implemented in the Node B 10, a transport format combination indicator (TFCI) content indicates a combination of a rate matching scheme and a channel coding scheme will be required in a control slot on the UL DPCH. When the BTFD scheme is implemented in the Node B 10, however, a transport format combination indicator (TFCI) indicates a combination of a rate matching scheme and a channel coding scheme is no longer required in a control slot on the UL DPCH.

FIG. 2 illustrates the slot configurations of a radio frame for the UMTS-FDD Release 99 UL DPCH, containing a dedicated physical data channel (DPDCH) radio frame and a dedicated physical control channel (DPCCH) radio frame multiplexed orthogonally by an in-phase (I) component and a quadrature (Q) component. Each DPCCH and DPDCH radio frame contains 15 time slots within 10 ms. The DPCCH radio frame is used to transfer physical layer control information.

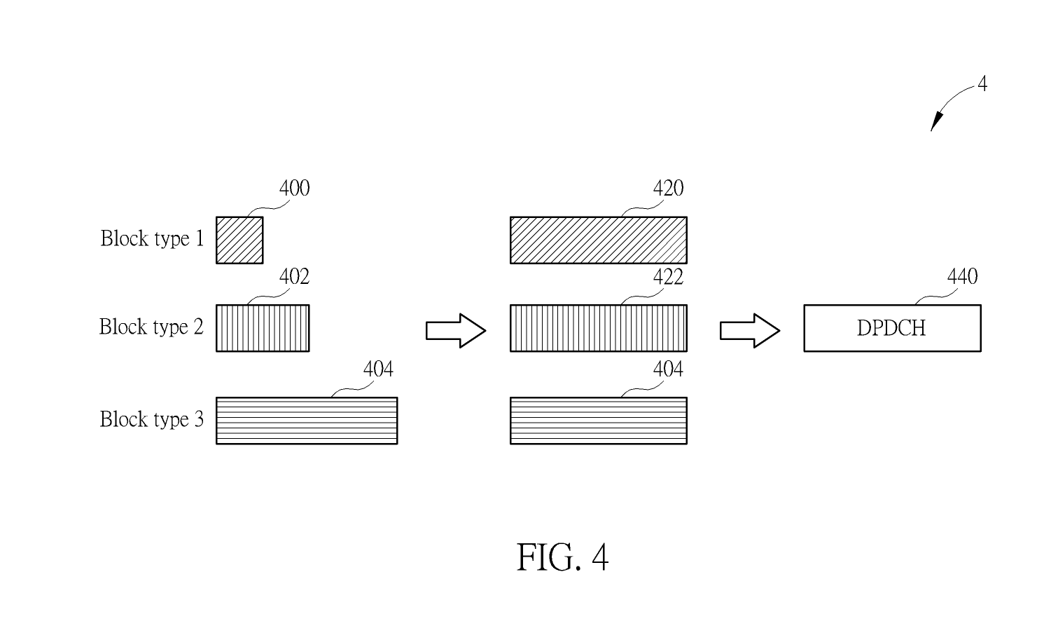

The DPCCH radio frame includes a Pilot field 220, a TFCI field 222, a feedback information (FBI) field 224, and a transmit power control (TPC) field 226. The Pilot field 220 contains pilot bits which allow the Node B 10 to maintain synchronization and to provide the channel estimation as well as the uplink transmit power control (TPC). More specifically, the pilot bits are used by the receiver of the Node B 10 to determine a Signal to Interference plus Noise Ratio (SINR) which is then compared with the uplink target SINR for generating uplink TPC command. On the other hand, the TPC command in the TPC field 226 is used for the downlink inner loop power control, instructing the Node B 10 to either increase or decrease the transmission power of downlink DPCH. The TFCI field 222 is optional, and contains a TFCI data to inform the Node B 10 of the transport combination at any instant in time. When the TFCI data is absent from the radio frame as shown in FIG. 3, the Node B 10 has to perform a blind detection of the transport format combination by CRC check results. In accordance with the UMTS-FDD Release 99 standard, the blind detection is only implemented for a fixed-rate data. The FBI field 224 includes an FBI data for closed-loop downlink transmission diversity mode or for site selection diversity transmit mode.

FIG. 3 illustrates a slot format #3 of a UL DPCCH slot according to an embodiment of the invention. The slot format #3 has a Pilot field 300, an FBI field 302 and a TPC field 304. The slot format #3 contains no TFCI data, since a blind detection has been implemented in the Node B 10. In consequence of the removal of the TFCI data, UL DPCCH slot format can be changed from slot format #2/#2A/#2B to slot format #3, and the data length of the Pilot field 300 is expand to 7 bits. The UL DPCCH slot formats defined by the UMTS-FDD Release 99 specification are shown in the table 1 below, where Npilot, NTPC, NTFCI, NFBI represent bit numbers in the pilot field, the TPC field, the TFCI field and the FBI field in the uplink slot defined in the UMTS-FDD Release 99.

TABLE 1

| Slot Form | | | | |
|---|---|---|---|---|
| at #i | Nₚᵢₗₒₜ | N_{TPC} | N_{TFCI} | N_{FBI} |
| 0 | 6 | 2 | 2 | 0 |
| 0A | 5 | 2 | 3 | 0 |
| 0B | 4 | 2 | 4 | 0 |
| 1 | 8 | 2 | 0 | 0 |
| 2 | 5 | 2 | 2 | 1 |
| 2A | 4 | 2 | 3 | 1 |
| 2B | 3 | 2 | 4 | 1 |
| 3 | 7 | 2 | 0 | 1 |
| 4 | 6 | 2 | 0 | 2 |
| 5 | 5 | 1 | 2 | 2 |
| 5A | 4 | 1 | 3 | 2 |
| 5B | 3 | 1 | 4 | 2 |

Since the TFCI field is removed in the present embodiment, the data length of the pilot field 300 must be increased, leading to an increased accuracy when estimating the signal quality for the channel as well as the channel impulse response.

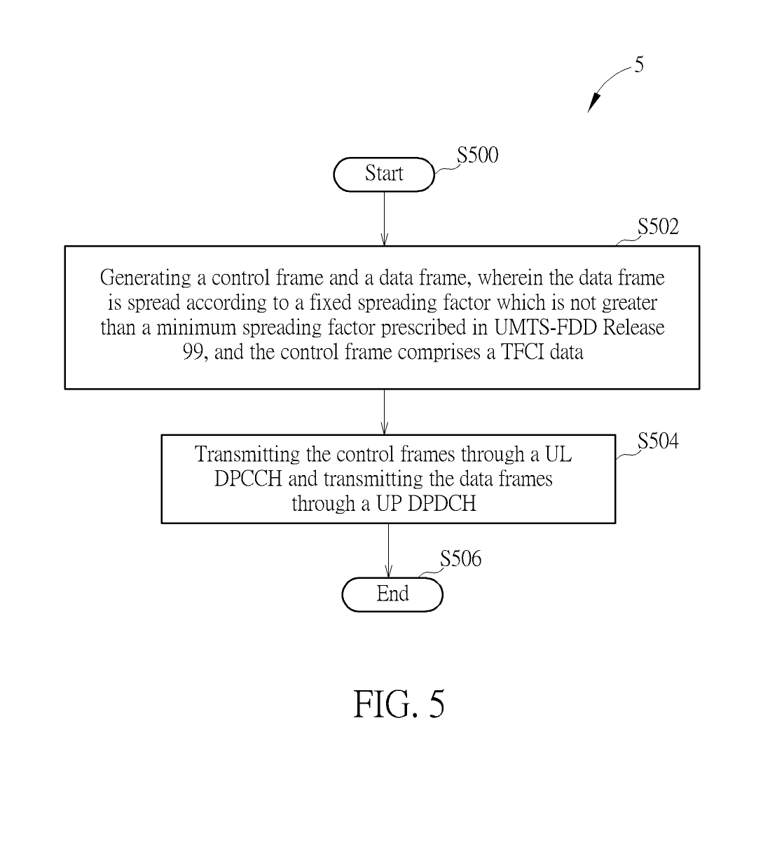

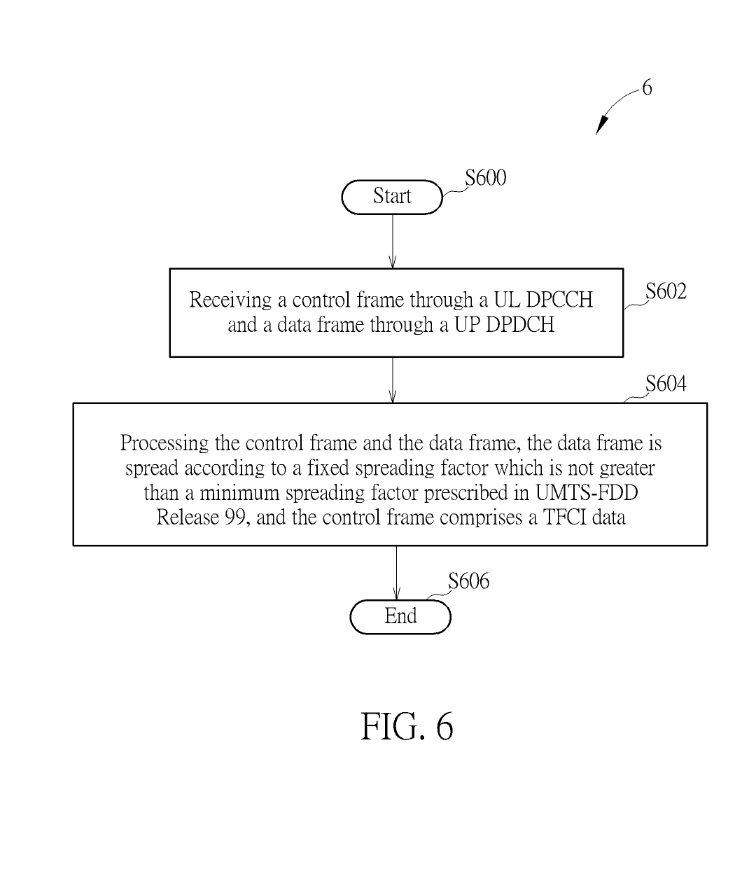

In some embodiments where the closed loop transmit diversity (CLTD) and site selection transmit diversity are not applied, the FBI field 302 can also be removed from the slot format, rendering further increased available data space for the pilot field 300 and the TPC field 304, in this case, slot format #1 is used and the pilot field 300 is increased to 8 bits. The BTFD method incorporated with the UL DPCCH slot formats is detailed in the methods 5 through 8 shown in FIGS. 5-8.

Before being transmitted over the UL DPCH, the UL DPDCH and DPCCH radio frames on the in-phase (I) and quadrature-phase (Q) components are multiplied separately by different OVSF spreading codes, and then multiplied by UE-specific scrambling codes to separate transmission for different UEs in the cell coverage. The spreading factor of the spreading code for the DPCCH radio frames may be 256. The spreading factor of the spreading code for the UL DPDCH radio frames may range from 4 to 256, and may vary on a frame by frame basis prescribed in UMTS-FDD Release 99 specification. For reducing the complexity of the receiver, a fixed spreading factor scheme for the UL DPDCH is employed in embodiments of the present invention. Each radio frame transmitted through the UL DPDCH comprises data with the same spreading factor, which is predetermined and known by each side of the UL DPDCH in advance.

FIG. 4 depicts a rate matching method 4 according to an embodiment of the invention. The rate matching method 4 illustrates how three possible data block sizes can be encoded to support a blind detection method for a variable-rate data on the Node B 10. The variable-rate data has a data rate less than 64 k bits per second (bps), and may be a limited block size less than 244 bits, which has a variable data rate. In certain embodiments, the block size may be up to 400 or 500 bits. Further, the variable-rate data contains no discontinuous transmission (DTX) bit on the UL DPDCH. In some embodiments, the variable-rate data is a speech data that has three possible transport format combinations and three possible data rates for “speech”, “mute”, or “background noise” (also known as Silence Insertion Descriptor SID) data which corresponds to a Block type 3, a Block type 2 and a Block type 1, respectively, as illustrated in FIG. 4. Each data block includes data bits originating from one or more data sources in a continuous or discontinuous manner. The data bits are collected over time to render one of the three block types shown in FIG. 4.

The Block types 1-3 are different in their data lengths. The UE 14 is configured to take the Block types 1-3 and make them equal in length (fixed data length or fixed data size) by a predetermined repetition pattern, or simply repeat the block data until a fixed data length is filled. For example, the UE 14 can directly repeat the block 400 four times to derive an encoded block 420, repeat the block 402 twice to produce the encoded block 422, or retain the block 404 without repetition. Hence, three blocks 420, 422 and 404 are equal in their data lengths. Next, the UE 14 can apply a spreading code with fixed spreading factor to the encoded blocks 420, 422 and 404, and then transmit the spread data over the UL DPDCH to the Node B 10. The fixed data length may be the longest data length among all available data lengths. For example, the fixed data length in FIG. 4 is the data length of the Block type 3.

In some embodiments, the UE 14 can apply a bit-by-bit repetition to the block data until the fixed data length is reached. For example, the UE 14 can repeat the block 402 in a bit-by-bit manner such that each bit is repeated once to generate the encoded block 422. In some embodiments, the UE 14 can apply a multi-bit-by-multi-bit repetition to the block data until the fixed data length is reached. For example, the UE 14 can repeat the block 402 in a 2-bit-by-2-bit manner such that every 2 bits are repeated once to generate the encoded block 422. In some other embodiments, the UE 14 can apply a random block repetition until the fixed data length is reached.

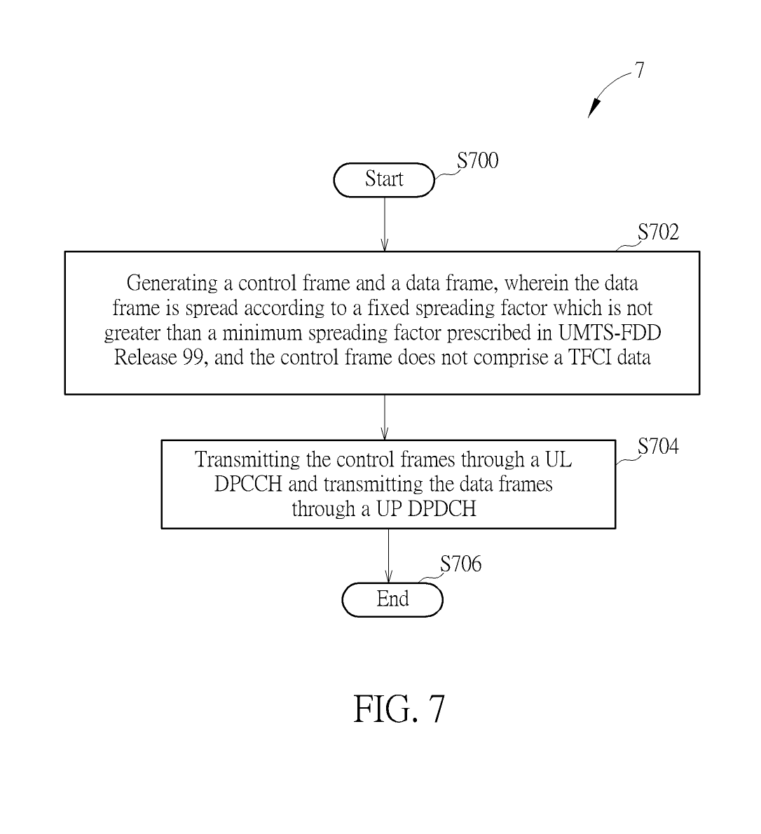

The rate matching method 4 is adopted by the UE 14 to provide a fixed-length data block which can be used in data processing methods 5 and 7 shown in FIG. 5 and FIG. 7, respectively.

FIG. 5 is a flowchart of a data processing method 5 performed by a UMTS-FDD device according to an embodiment of the invention, incorporating the UE 14 in FIG. 1. The data processing method 5 is applied to generate the UL DPCH data by the UE 14, and can incorporate the data processing method 6 in a UMTS FDD system with TFCI scheme.

Upon initialization (S500), the UE 14 is configured to generate a control radio frame and a data radio frame (S502), wherein the control radio frame may include the pilot data, the TFCI data, the FBI data and the TPC data as defined in the UMTS-FDD Release 99 standard. In addition, the data frame is rate matched according to a fixed rate matched data length, and then spread according to a fixed spreading factor which is not greater than a minimum spreading factor prescribed in UMTS-FDD Release 99. Specifically, the UE 14 is configured to rate match the user data (low rate data) to the fixed rate matched data length (fixed data length), and spread the rate matched data with the fixed spreading factor to produce the data radio frame. More specifically, a different number of repeated bits or a different repetition pattern may be employed for rate matching the user data, such as the bit by bit repetition, the multi-bit by multi-bit repetition, the random block repetition or any other repetition patterns for different data block sizes of the speech data.

Next, the UE 14 is configured to transmit the control radio frame and the rate matched and spread data radio frame over the UL DPCCH and the UL DPDCH, respectively, to the Node B 10 (S504), where the data radio frame will be decoded by the TFCI scheme. The TFCI scheme will be detailed later. At this point, the data processing method 5 is completed and exited (S506).

The UE 14 may transmit the user data using a data radio frame on the UL DPDCH. The user data is a low rate data with a data rate less than 64 k bps. The user data is spread by a fixed spreading factor prior to the UL data transmission. In the case of the variable spreading factor, the UE 14 is configured to determine a rate matched data length and a corresponding spreading factor based on the block type of the user data. Accordingly, the UE 14 is next configured to rate match the user data to the rate matched data length and spread the rate matched data with the corresponding spreading factor, thereby generating the data radio frame to be delivered over the UL DPDCH. In this embodiment, the UE 14 employs a fixed rate matched data length and a fixed spreading factor irrespective of the block type of the user data. The UE 14 is configured to rate match the user data to the fixed rate matched data length and then spread the rate matched data with the fixed spreading factor to produce the data radio frame. In addition, the rate matching scheme may be indicated in the TFCI for facilitating the decoding process of the Node B 10.

FIG. 6 is a flowchart of a data processing method 6 performed by a UMTS-FDD device according to another embodiment of the invention, incorporating the Node B 10 in FIG. 1.

Upon startup, the Node B 10 is initiated to detect radio frames on the uplink DPCH (S600). The receiver of the Node B 10 can detect and receive a first radio frame on the uplink DPCH, which contains DPCCH slots and DPDCH slots. In the embodiment, the TCFI data is included in the DPCCH slot, as depicted in FIG. 2. A TFCI scheme is therefore implemented in the Node B 10 to determine a transport format combination for a low rate data. The low rate data has a data rate less than 64 k bps and a limited block size less than 244 bits. The low rate data is a circuit-switched data. In some embodiments, the low rate data is a speech data that has three possible transport format combinations.

Upon receiving the low rate data (first data) from a DPDCH slot of the first radio frame on the UL DPCH (S602), the control circuit of the Node B 10 is configured to process the low rate data (S604). The low rate data is spread with a fixed spreading factor. The fixed spreading factor is not greater than a minimum spreading factor defined in the UMTS-FDD Release 99 specification.

Based on the received data, the control circuit of the Node B 10 can proceed to perform de-spreading according to the fixed spreading factor, and perform de-rate matching upon the de-spread data according to a rate matching scheme indicated in the TFCI to generate a data, wherein the rate matching schemes involve a different number of repeated bits or a different repetition pattern employed by the UE 14. For example, the coding schemes in FIG. 4 applies the bit by bit repetition, the multi-bit by multi-bit repetition, the random block repetition, or other repetition patterns for different data block sizes of the speech data. Therefore, the corresponding decoding schemes will separate the de-spread data according to the repetition pattern indicated by the TFCI. At this point, the data processing method 6 is completed and exited (S606).

The data processing method 6 employs a spreading code with fixed spreading factor to determine a correct transport format for a low rate data on the UL DPDCH, which means that a single de-spreading candidate is left for the UL DPDCH, thereby simplifying the circuit design of the receiver (Node B 10).

FIG. 7 is a flowchart of a data processing method 7 performed by a UMTS-FDD device according to yet another embodiment of the invention, incorporating the UE 14 in FIG. 1. The data processing method 7 is applied to generate the UL DPCH data by the UE 14, and can incorporate the data processing method 8 in a UMTS FDD system with BTFD scheme.

Upon initialization (S700), the UE 14 is configured to generate a control radio frame and a data radio frame (S702), wherein the control radio frame may include the pilot data, the FBI data and the TPC data. Please note that the control radio frame does not include the TFCI data. The pilot data may have a data length as the maximum value that defined in the UMTS-FDD Release 99 standard to thereby improve channel estimation, SINR estimation and synchronization performance. In addition, the data frame is rate matched according to a fixed rate matched data length, and then spread according to a fixed spreading factor which is not greater than a minimum spreading factor prescribed in UMTS-FDD Release 99. The UE 14 is configured to rate match the user data (low rate data) to the fixed rate matched data length (fixed data length), and spread the rate matched data with the fixed spreading factor to produce the data radio frame. More specifically, a different number of repeated bits or a different repetition pattern may be employed for rate matching the user data, such as the bit by bit repetition, the multi-bit by multi-bit repetition, the random block repetition or any other repetition patterns for different data block sizes of the speech data.

Next, the UE 14 is configured to transmit the control radio frame and the rate matched and spread data radio frame over the UL DPCCH and the UL DPDCH, respectively, to the Node B 10 (S704), where the data radio frame will be decoded by the BTFD scheme, which will be detailed later. At this point, the data processing method 7 is completed and exited (S706).

Although the TFCI data is absent in the control radio frame, the Node B 10 is still able to determine the transport format combination of the user data on the UL DPDCH based on the BTFD scheme, as will be detailed later. The UE 14 may transmit the user data using a data radio frame on the UL DPDCH. The user data is a low rate data with a data rate less than 64 k bps. The user data is spread by a fixed spreading factor prior to the UL data transmission. In the case of the variable spreading factor, the UE 14 is configured to determine a rate matched data length and a corresponding spreading factor based on block type of the user data. Accordingly, the UE 14 is configured to rate match the user data to the rate matched data length and spread the rate matched data with the corresponding spreading factor, thereby generating the data radio frame to be delivered over the UL DPDCH. In this embodiment, the UE 14 employs a fixed rate matched data length and a fixed spreading factor irrespective of the block type of the user data. The UE 14 is configured to rate match the user data to the fixed rate matched data length and then spread the rate matched data with the fixed spreading factor to produce the data radio frame.

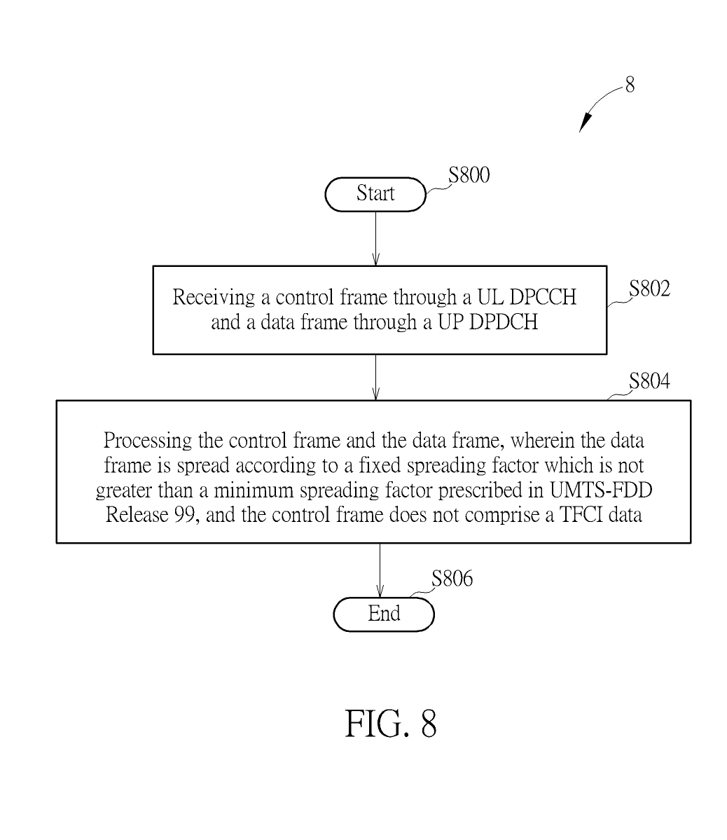

FIG. 8 is a flowchart of a data processing method 8 performed by a UMTS-FDD device according to an embodiment of the invention, incorporating the Node B 10 in FIG. 1.

Upon startup, the Node B 10 is initiated to detect radio frames on the uplink DPCH (S800). The receiver of the Node B 10 can detect and receive a first radio frame on the uplink DPCH, which contains DPCCH slots and DPDCH slots. In the embodiment, the TCFI data is eliminated from the DPCCH slot, as depicted by the DPCCH slot 3 in FIG. 3. A blind detection is therefore implemented in the Node B 10 to determine a transport format combination for a low rate data. The low rate data has a data rate less than 64 k bps and a limited block size less than 244 bits. The low rate data is a circuit-switched data. In some embodiments, the low rate data is a speech data that has three possible transport format combinations.

Upon receiving the low rate data (first data) from a DPDCH slot of the first radio frame on the UL DPCH (S802), the control circuit of the Node B 10 is configured to process the low rate data (S804). The low rate data is de-spread with a fixed spreading factor, which is not greater than a minimum spreading factor defined in the UMTS-FDD Release 99 specification.

Based on the de-spread data, the control circuit of the Node B 10 can proceed to perform de-rate matching on the de-spread data with a plurality of de-rate matching schemes. More specifically, each decoding scheme may involve decoding the de-spread data with a different number of repeated bits or a different repetition pattern. Accordingly, the coding schemes in FIG. 4 applies the bit by bit repetition, the multi-bit by multi-bit repetition, the random block repetition, or other repetition patterns for different data block sizes of the speech data. The corresponding decoding schemes will separate the de-spread data according to the bit by bit repetition, the multi-bit by multi-bit repetition, the random block repetition, or other repetition patterns. In the example of speech data, the control circuit of the Node B 10 is configured to de-rate match the de-spread data using three different repetition patterns to recover three block types of de-rate matched data, and buffer the three de-rate matched data in a local memory in the Node B 10.

Based on all de-rate matched data, the control circuit of the Node B 10 can determine a correct transport format combination for the received low rate data. In some embodiments, the control circuit is configured to determine the correct transport format combination by an error detection coding scheme such as a cyclic redundancy check (CRC), a parity bit, a checksum, a repetition code, or other error correcting codes. For example, the control circuit can apply the CRC to the three buffered decoded data. Based on the CRC results which represent accuracy of the de-rate matched data, the control circuit can determine which one of the three decoded data has a correct transport format combination that is being used by the low rate data. The correct transport format combination will show no error in the CRC result. In other embodiments, the control circuit is configured to determine the correct transport format combination based on a data quality metric derived during the channel decoding. For example, the control circuit is configured to decode all three de-rate matched data by a decoder to determine the decoding metrics that rank the degree of correctness in the three de-rate matched data. Based on the decoding metrics which represent accuracy of the de-rate matched data, the control circuit can determine which one of the three de-rate matched data has a correct transport format combination that is being used by the low rate data. The correct transport format combination will display a highest rank in the decoding metrics.

After the correct transport format combination for the low rate data is determined, the data processing method 8 is completed and exited (S806).

The data processing method 8 employs a fixed spreading factor to determine a correct transport format combination for a low rate data on the UL DPDCH, thereby reducing the use of the TFCI data on the UL DPCCH, and increasing data space for the pilot data on the UL DPCCH. This results in an increased accuracy in signal quality estimation and channel estimation, as well as an improvement in the system capacity.

As used herein, the term “determining” encompasses calculating, computing, processing, deriving, investigating, looking up (e.g. looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in an alternative embodiment, the processor may be any commercially available processor, controller, microcontroller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing method, performed by a Universal Mobile Telecommunications System Frequency Division Duplexing (UMTS-FDD) device, comprising:
generating a control frame and a data frame, wherein the data frame is spread according to a fixed spreading factor which is not greater than a minimum spreading factor prescribed in a UMTS-FDD Release 99 specification; and
transmitting the control frame through an uplink dedicated physical control channel (UL DPCCH) and transmitting the data frame through an uplink dedicated physical data channel (UP DPDCH).

2. The method of claim 1, wherein the control frame comprises a transport format combination indicator (TFCI) data, and the step of generating the data frame comprises:
performing rate matching upon a data to a fixed data length to generate a rate matched data, wherein a rate matching scheme of the rate matching is indicated in the TFCI; and
spreading the rate matched data to generate the data frame according to the fixed spreading factor.

3. The method of claim 2, wherein the step of performing the rate matching upon the data to the fixed data length to generate the rate matched data comprises:
when a length of the data is less than a length of the data frame, repeating bits of the data bit by bit according to the length of the data and the length of the data frame to generate the rate matched data.

4. The method of claim 2, wherein the step of performing the rate matching upon the data to the fixed data length to generate the rate matched data comprises:
when a length of the data is less than a length of the data frame, repeating bits of the data multi-bit by multi-bit according to the length of the data and the length of the data frame to generate the rate matched data.

5. The method of claim 2, wherein the step of performing the rate matching upon the data to the fixed data length to generate the rate matched data comprises:
when a length of the data is less than a length of the data frame, repeating bits of the data in a random manner according to the length of the data and the length of the data frame to generate the rate matched data.

6. The method of claim 1, wherein the control frame does not comprise a transport format combination indicator (TFCI) data, and the step of generating the data frame comprises:
performing rate matching upon data to a fixed data length to generate a rate matched data; and
spreading the rate matched data to generate the data frame according to the fixed spreading factor.

7. The method of claim 6, wherein the step of performing the rate matching upon the data to the fixed data length to generate the rate matched data comprises:
when a length of the data is less than a length of the data frame, repeating bits of the data bit by bit according to the length of the data and the length of the data frame to generate the rate matched data.

8. The method of claim 6, wherein the step of performing the rate matching upon the data to the fixed data length to generate the rate matched data comprises:
when a length of the data is less than a length of the data frame, repeating bits of the data multi-bit by multi-bit according to the length of the data and the length of the data frame to generate the rate matched data.

9. The method of claim 6, wherein the step of performing the rate matching upon the data to the fixed data length to generate the rate matched data comprises:
when a length of the data is less than a length of the data frame, repeating bits of the data in a random manner according to the length of the data and the length of the data frame to generate the rate matched data.

10. A data processing method, performed by a Universal Mobile Telecommunications System Frequency Division Duplexing (UMTS-FDD) device, comprising:
receiving a control frame through an uplink dedicated physical control channel (UL DPCCH) and a data frame through an uplink dedicated physical data channel (UL DPDCH); and
processing the control frame and the data frame, wherein the data frame is de-spread according to a fixed spreading factor which is not greater than a minimum spreading factor prescribed in a UMTS-FDD Release 99 specification.

11. The method of claim 10, wherein the control frame comprises a transport format combination indicator (TFCI) data, and the step of processing the data frame comprises:
de-spreading the data frame to generate a de-spread data according to the fixed spreading factor; and
performing de-rate matching upon the de-spread data according to a rate matching scheme indicated in the TFCI to generate a data according to the TFCI.

12. The method of claim 11, wherein the rate matching scheme comprises repeating bits of the data bit by bit according to a length of the data and a length of the data frame.

13. The method of claim 11, wherein the rate matching scheme comprises repeating bits of the data multi-bit by multi-bit according to a length of the data and a length of the data frame.

14. The method of claim 11, wherein the rate matching scheme comprises repeating bits of the data in a random manner according to a length of the data and a length of the data frame.

15. The method of claim 10, wherein the control frame does not comprise a transport format combination indicator (TFCI) data, and the step of processing the data frame comprises:
de-spreading the data frame to generate a de-spread data according to the fixed spreading factor;
performing de-rate matching upon the de-spread data according to a plurality of rate matching schemes to generate a plurality of de-rate matched data; and
selecting one of the plurality of de-rate matched data by performing error detection upon the plurality of de-rate matched data respectively.

16. The method of claim 15, wherein the plurality of rate matching schemes comprises repeating bits of the data bit by bit according to a length of the data and a length of the data frame.

17. The method of claim 15, wherein the plurality of rate matching schemes comprises repeating bits of the data multi-bit by multi-bit according to a length of the data and a length of the data frame.

18. The method of claim 15, wherein the plurality of rate matching schemes comprises repeating bits of the data in a random manner according to a length of the data and a length of the data frame.
